(19) United States
(12) Patent Application Publication
(10) Pub. No.: US 2005/0168638 A1
(43) Pub. Date: Aug. 4, 2005

(54) Information processing apparatus

(76) Inventor: Takeshi Iwata, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/034,035

(22) Filed: Jan. 12, 2005

(30) Foreign Application Priority Data
Jan. 30, 2004 (JP) P2004-24021

(51) Int. Cl. H04N 7/00

(52) U.S. Cl. 348/552

(57) ABSTRACT

According to one embodiment of the invention, an information processing apparatus comprises a memory which stores an operating system to be booted in response to a certain operation, a content output unit which outputs content data, and a display unit which displays content data output by the content output unit even though the boot of the operating system has not completed.

### CROSS-REFERENCE TO RELATED APPLICATIONS

This application is based upon and claims the benefit of priority from Japanese Patent Application No. 2004-24021, filed Jan. 30, 2004, the entire contents of which are incorporated herein by reference.

### BACKGROUND

1. Field

One embodiment of the invention relates to an information processing apparatus for displaying content data such as a TV program received from a receiver of TV broadcasting, and audio and visual data read from a disk drive apparatus.

2. Description of the Related Art

Recently, personal computers (hereinafter “PCs”) are being provided with a viewing function of audio and visual (hereinafter “AV”) information. Hence, a PC enables its user to view TV broadcast programs received from a receiver and AV information read from a disk drive apparatus such as a DVD and a CD. In such PCs, under management and control of an operating system (hereinafter “OS”), there are two system configurations. One configuration is for driving and controlling the viewing function of AV information, and the other configuration is for independently activating the AV function without booting the OS. For example, Japanese Patent Application Publication (KOKAI) No. 2002-108486 discloses such type of PC.

In the system configuration for driving and controlling the viewing function of the AV information under the OS control, a user needs to wait for completion of boot of the OS when viewing the AV information. In addition, in the system configuration for independently activating the AV function without booting the OS, in the case of recording the AV information that the user is viewing, for example, in a storage apparatus such as a hard disk drive (referred to as a “HDD”) managed by the OS, the boot of the OS should be carried out. This may prevent the recordation of AV information at an intended point of time.

### BRIEF DESCRIPTION OF THE SEVERAL VIEWS OF THE DRAWINGS

The accompanying drawings, which are incorporated in and constitute a part of the specification, illustrate embodiments of the invention, and together with the detailed description of the embodiments given below, serve to explain the principles of the invention.

FIG. 1 is an exemplary diagram showing an information processing apparatus according to a first embodiment of the present invention;

FIG. 2 is an exemplary block diagram showing a component configuration of hardware of the information processing apparatus according to the first embodiment;

FIG. 3 is an exemplary flow chart for illustrating a system boot processing routine when an AV playback switch is powered on according to the first embodiment;

FIG. 4 is an exemplary diagram for illustrating an operating condition of an OS according to the first embodiment;

FIG. 5 is an exemplary display screen that is displayed on a LCD during the system boot processing routine executed when the AV playback switch is powered on according to the first embodiment;

FIG. 6 is an alternative display screen that is displayed on a LCD during the system boot processing routine executed when the AV playback switch is powered on according to the first embodiment;

FIG. 7 is a further alternative display screen that is displayed on a LCD during the system boot processing routine executed when the AV playback switch is powered on according to the first embodiment;

FIG. 8 is an exemplary external view of a remote controller that operation buttons are arranged thereon according to the first embodiment;

FIG. 9 is an exemplary flow chart for illustrating a switching procedure from display of AV contents by the ON operation of the AV playback switch to display of data under control of an OS according to the first embodiment;

FIG. 10 is an exemplary flow chart for illustrating a switching procedure from display of the data under control of the OS to display of the AV contents according to the first embodiment; and

FIG. 11 is an exemplary block diagram showing a component configuration of hardware of the information processing apparatus according to a second embodiment of the present invention.

### DETAILED DESCRIPTION

Various embodiments according to the present invention will be described hereinafter with reference to the accompanying drawings. In general, according to one embodiment of the invention, an information processing apparatus comprises a memory which stores an operating system to be booted in response to a certain operation, a content output unit which outputs content data, and a display unit which displays content data output by the content output unit even though the boot of the operating system has not completed.

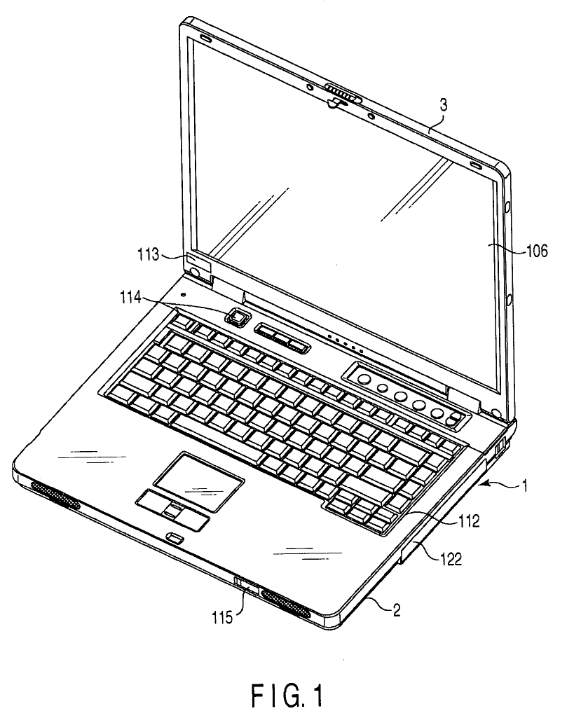

With reference to FIG. 1, an information processing apparatus according to an embodiment of the present invention will be described. This information processing apparatus is realized, for example, as a notebook-size personal computer (hereinafter “PC”). It is contemplated, however, that the information processing apparatus may be implemented as any type of portable computer or a personal digital assistant.

FIG. 1 shows an information processing apparatus 1 which is configured by a main body 2 and a display unit 3. In FIG. 1, the display unit 3 of the information processing apparatus 1 is opened to the main body 2. The display unit 3 features a Liquid Crystal Display (hereinafter “LCD”) 106 is incorporated, and the LCD 106 is located substantially at a center of the display unit 3.

The display unit 3 is located to rotate between an open position and a closed position against the main body 2. In the display unit 3, an infrared receiving unit (hereinafter “IR port”) 113 is provided. The IR port 113 receives infrared rays with a signal showing a control content, the signal being outputted from a remote controller to remotely control the information processing apparatus 1.

The main body 2 is substantially shaped in a box configuration, and on the upper surface of the main body 2, a keyboard 112 and a power button 114 for powering on and off a power source of the information processing apparatus 1 are allocated. The main body 2 contains a DVD drive 122.

An AV playback switch 115 to be described later is located at a front surface of the main body 2. If the AV playback switch 115 is powered on, for example, AV contents stored in an optical disk that is set in the DVD drive 122 are played back so that pictures of the AV contents are displayed on the LCD 106.

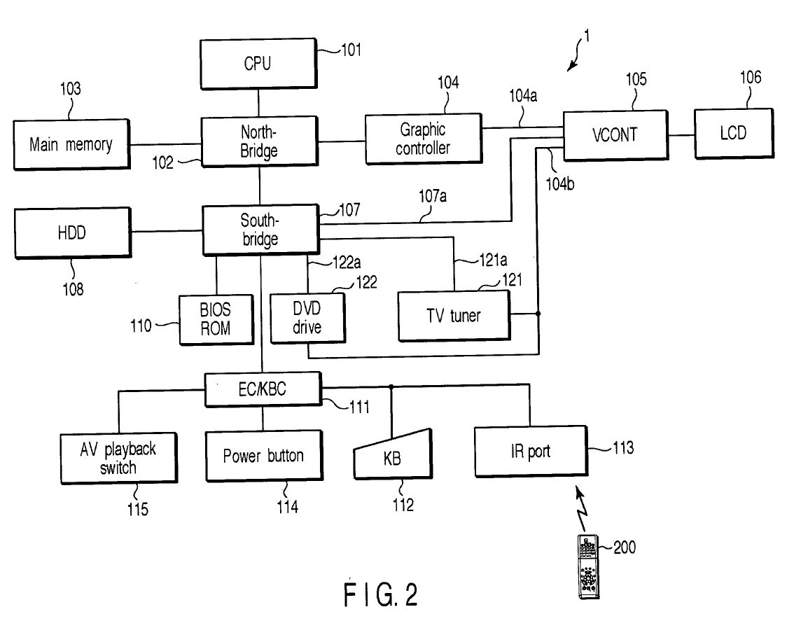

Next, with reference to FIG. 2, a component configuration of the information processing apparatus 1 will be described below.

The information processing apparatus 1 is composed from various constituent elements such as a central processing unit (hereinafter “CPU”) 101, a north bridge 102 and a south bridge 107; a main memory 103; a BIOS-ROM 110; a graphic controller 104; an image correction controller (hereinafter “VCONT”) 105; an LCD 106; a hard disk drive apparatus (hereinafter “HDD”) 108; an embedded controller/keyboard controller (hereinafter “EC/KBC”) 111; the keyboard 112; the IR port 113; a TV tuner 121; and a DVD drive 122.

The CPU 101 is a processor that is adapted to control the operation of the information processing apparatus 1 according to this embodiment. For instance, the CPU 101 executes an operating system (hereinafter “OS”) loaded from the HDD 108 as an external storage device to the main memory 103 and various application/utility programs. In addition, the CPU 101 executes a Basic Input Output System (hereinafter “BIOS”) that is stored in the BIOS-ROM 110.

The north bridge 102 is a bridge device to connect a local bus of the CPU 101 and the south bridge 107. In the north bridge 102, a memory controller for controlling the access of the main memory 103 is incorporated. In addition, the graphic controller 104 is connected to the north bridge 102.

The main memory 103 stores the OS, various application programs and various utility programs to be executed by the CPU 101. The various programs stored in the main memory 103 include, for example, a screen control program as a part of a user interface of the information processing apparatus 1, and a control program for setting a TV program and a timer for recording, and a program for performing a data management function in response to the setting of the control program.

The graphic controller 104 controls data to be displayed on the LCD 106 of the display unit 3. This data is referred to as the display data hereinafter. In addition, the VCONT 105 is connected to the graphic controller 104 via a signal line 104a. For example, the VCONT 105 performs picture processing such as a motion correction processing, with respect to the display data to be outputted from the graphic controller 104. The VCONT 105 is also connected to the south bridge 107 to be described later via a signal line 107a, and performs the picture processing such as the motion correction processing, with respect to the display data to be inputted therein on the basis of a signal to be outputted from the south bridge 107. The display data processed by the VCONT 105 is displayed on the LCD 106.

The south bridge 107 is a bridge device to be connected to the north bridge 102. The south bridge 107 is connected to the HDD 108, the BIOS-ROM 110, and the EC/KBC 111. In addition, the south bridge 107 is connected to the VCONT 105 via a signal 107a, the TV tuner 121 via a signal line 121a, and the DVD drive 122 via a signal line 122a. In general, a TV tuner 121, a DVD drive 122 and any other device adapted to provide content data may be referred to as a “content output unit.”

The HDD 108 stores the OS, a device driver, an application program of an execution target, data to be generated by executing the application program, and the like therein. The information stored in the HDD 108 is transferred to the memory 103 as needed.

The BIOS to be executed by the CPU 101 is stored in the BIOS-ROM 110. An initialization processing routine of the BIOS includes a system boot processing routine to be described later in detail.

The TV tuner 121 connected to the south bridge 107 via the signal line 121a receives TV broadcasting program data, which is one of content data, of a channel of which viewing is requested from the image processing apparatus 1 via the keyboard 112, via the IR/port 113 and a remote controller, or a LAN. The TV broadcasting program data is decoded by an incorporated NTSC decoder, and then converted into TV broadcasting program data that is compressed and coded via an MPEG encoder. When a user views the TV broadcasting program data, the compressed and coded TV broadcasting program data is decoded and decompressed by the incorporated MPEG decoder, and further, the decoded TV broadcasting program data is displayed on the LCD 106. On the other hand, in the case of recording the TV broadcasting program data, the TV broadcasting program data compressed and coded by the MPEG encoder is stored in the HDD 108.

The DVD drive 122 connected to the south bridge 107 via the signal line 122a is a type of an optical disk drive. The DVD drive 122 reproduces content data, for example, stored in the DVD disk.

The TV tuner 121 and the DVD drive 122 are connected to the VCONT 105 via a signal line 104b. Although described below in detail, by powering on the AV playback switch 115, the content data to be outputted from the TV tuner 121 or the DVD drive 122 are outputted to the VCONT 105 via the signal line 104b, and further, the contents are outputted from the VCONT 105 to the LCD 106.

The EC/KBC 111 is a one-chip microcomputer in which the embedded controller for managing an electric power and the keyboard controller for controlling the key board 112 are integrated. The EC/KBC 111 powers on and powers off the information processing apparatus 1 in response to the operation of the power button 114 by the user. The keyboard unit 112, the IR port 113, the power button 114, and the AV playback switch 115 are connected to the EC/KBC 111.

The keyboard 112 is one of input units in the information processing apparatus 1.

The IR port 113 receives an infrared signal to be transmitted by a remote controller 200, and transmits operation information indicated by the infrared signal to the CPU 101 via the EC/KBC 111, the south bridge 107, and the north bridge 102. The IR port 113 stores the operation information in an incorporated register upon receiving the infrared signal, and further, the IR port 113 generates interrupt with respect to the CPU 101. Then, if the CPU 101 requires reference of the incorporated register in response to this interrupt, the IR port 113 outputs the operation information on a data bus connecting the EC/KBC 111 with the south bridge 107.

The power button 114 is provided to control the supply of power from a power source with respect to one or more devices (referred to as a “device group), such as the CPU 101 and the memory 103 implemented with the information processing apparatus 1, prior to booting the OS. more specifically, when the user pushes down the power button 114, power is supplied to the device group, and then, the CPU 101 executes the system boot processing routine of the BIOS provided in the BIOS-ROM 110 so as to boot the OS. When the CPU 101 executes the system boot processing routine, for example, such as a Power On Self Test or the like, the result of this processing routine is displayed on the LCD 106.

The AV playback switch 115 is used when the user views TV programs or contents stored in the optical disk. If the user wants to view, for example, the TV program, the user slides the AV playback switch 115, for example, to the right. On the other hand, if the user wants to view the contents stored in the optical disk, the user slides the AV playback switch 115, for example, to the left.

If the user powers on the AV playback switch 115, for example, by sliding the AV playback switch to the right, the picture of the AV contents is displayed on the LCD 106, and the system boot routine of the BIOS is executed to boot the OS.

Next, the processing procedure when the AV playback switch 115 is powered on will be described with reference to FIGS. 2 to 7.

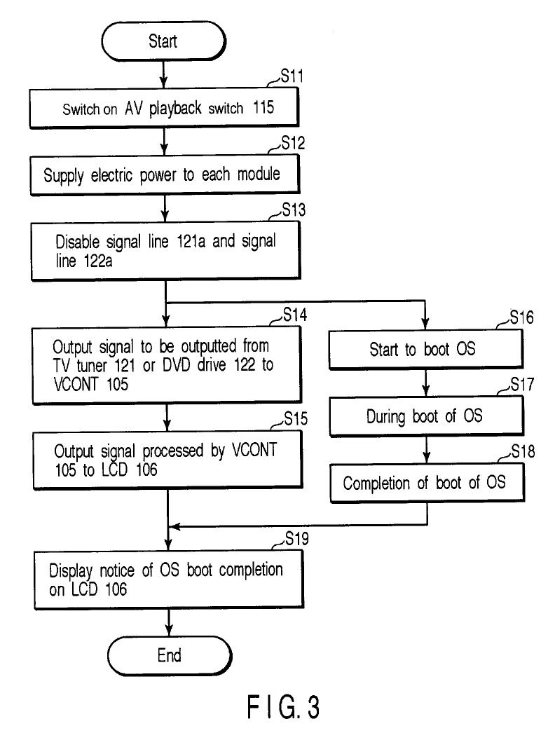

FIG. 3 shows the system boot processing routine to be executed when the AV playback switch 115 is powered on.

If the user powers on the AV playback switch 115 of FIG. 2 (block S11), the EC/KBC 111 detects that the AV playback switch 115 is placed in an ON position. Then, the electric power is supplied by a Power Supply Controller (not shown) to respective device groups composing the present information processing apparatus 1, such as the CPU 101, the north bridge 102, the memory 103, the graphic controller 104, the VCONT 105, the LCD 106, the south bridge 107, the TV tuner 121, the DVD drive 122 and the like (block S12).

Once the electric power is supplied to the respective device groups, the CPU 101 sets one or more registers provided in the south bridge 107 to disable the signal lines 121a 122a (block S13).

If the signal line 121a and the signal line 122a are disabled, the south bridge 107 cannot control the TV tuner 121 and the DVD drive 122. A signal representing the TV program contents to be outputted from the TV tuner 121 or a signal representing the contents to be stored in the optical disk set in the DVD drive 122 is outputted to the VCONT 105 (block S14). The signal inputted from the TV tuner 121 or the DVD drive 122 into the VCONT 105, which performs appropriate picture processing to provide and outputs the processed data to the LCD 106 (block S15).

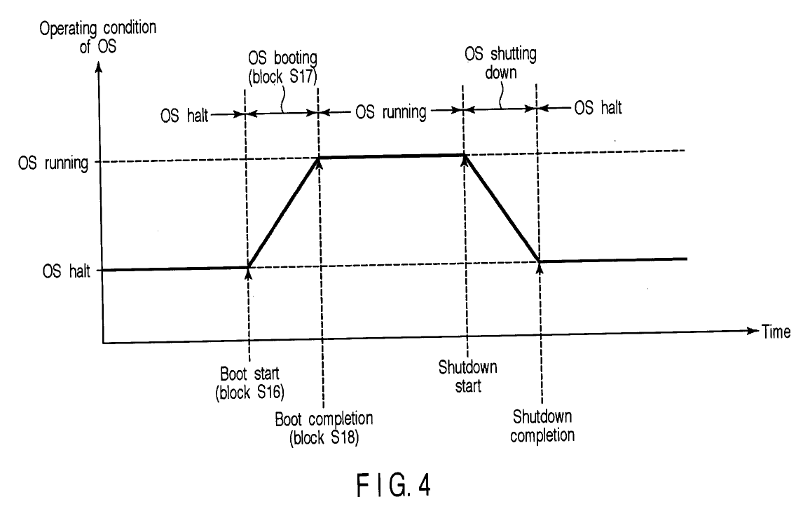

Next, with reference to FIG. 4, operating condition of the OS will be described. FIG. 4 shows operating conditions of the OS corresponding to each event; namely, BOOT START, BOOT COMPLETION, SHUTDOWN START, and SHUTDOWN COMPLETION. The BOOT START of the OS is an event for starting an operation to boot the OS under OS halt condition. Time period from the BOOT START of the OS to the BOOT COMPLETION is referred as “booting” the OS. A condition after the BOOT COMPLETION of the OS is referred as the “OS running.” The SHUTDOWN START of the OS is an event for starting an operation to shutdown the OS while the OS running. The time period from the SHUTDOWN START of the OS to the SHUTDOWN COMPLETION is referred as “shutting down” the OS. A condition after the SHUTDOWN COMPLETION of the OS is referred as the OS “halt” condition.

Returning back to block S15 of FIG. 3, when the VCONT 105 outputs the signal processed by the VCONT 105 to the LCD 106, subsequently, the pictures of the AV contents are displayed on the LCD 106, and the CPU 101 executes the system boot processing routine or the like of the BIOS stored in the BIOS-ROM 110, the boot of the OS is started (block S16). During booting of the OS (block S17), for example, a signal representing a screen indicating that the OS is booted up is transmitted from the north bridge 102 to the graphic controller 104 of FIG. 2. However, the graphic controller 104 does not output this signal to the VCONT 105. Accordingly, the screen indicating that the OS is booted up is not displayed on the LCD 106 and a signal representing the AV contents outputted from the TV tuner 121 (or the DVD drive 122) is outputted to the LCD 106.

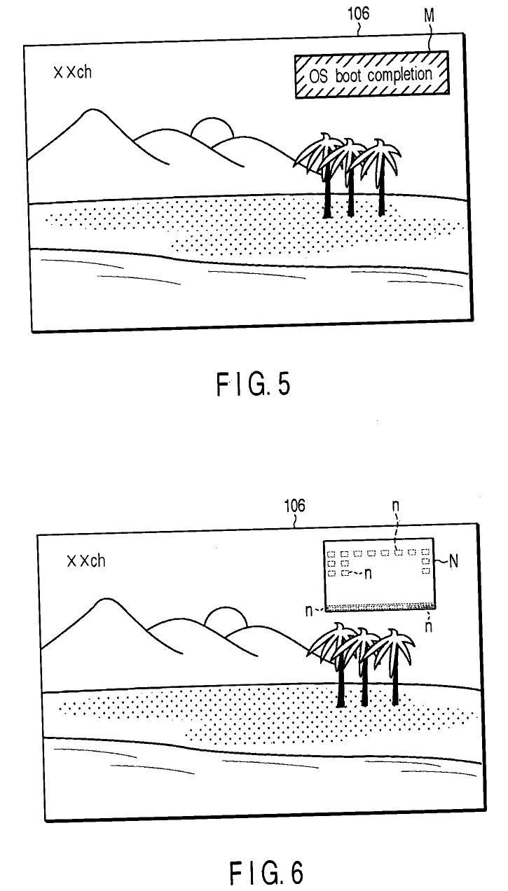

Once the OS boot processing is completed (block S18), as shown in FIG. 5, a message M indicating the end of the OS boot is displayed on the AV contents displayed on the LCD 106 (block S19). This message is displayed on the LCD 106 from the memory 103 via the north bridge 102, the south bridge 107, the signal line 107a, and the VCONT 105. The user recognizes completion of the OS boot when the message M comes out on the LCD 106.

Instead of showing the message M, as shown in FIG. 6, a computer screen N may be displayed on the LCD 106. the computer screen N is a miniature version reduced from normal computer screen which should be displayed on the LCD 106, in the case that the pictures of the AV contents is not displayed, right after the OS boot processing has been completed.

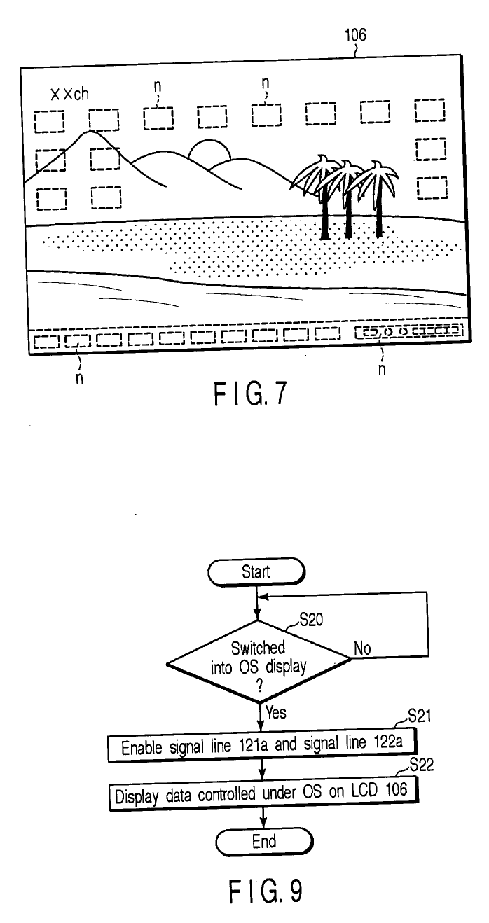

Alternatively, as shown in FIG. 7, the pictures of the AV contents may be superimposed on the normal computer screen including several icons n, without reduction. In this case, the pictures should be converted to be transparent.

The data for the computer screen shown in both FIG. 6 and FIG. 7, is transmitted from the CPU 101 to the LCD 106 via the north bridge 102, the graphic controller 104, and the VCONT 105, and is displayed thereon. The message M, the reduced computer screen N, and/or the superimposed AV content contribute to call attention to the user to recognize that booting the OS has been completed.

Next, a switching procedure from the display of the AV contents to the data display under the control of the OS upon activating the AV playback switch 115 (place in ON position) will be described below.

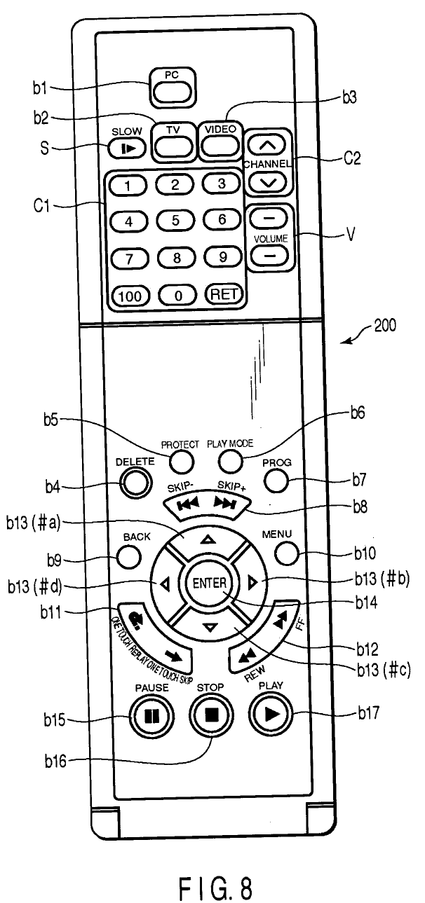

The switching procedure is triggered by an operation of a PC button of the remote controller 200 shown in FIG. 8. The remote controller 200 has several kind of the operational buttons.

In an upper part of the remote controller 200, there are the PC button b1, a TV button b2, a video button b3, numeral button c1 used for inputting numeral, a channel up/down button c2 used for changing channel sequentially, volume buttons v, and a slow playback button s. In addition, a delete button b4, a protect designation button b5, play mode selecting button b6, a program button b7, a skip button b8, a back button b9, a menu button b10, a one touch replay/one touch skip button b11, a rewind/fast-forward button b12, direction indicator buttons b13 (#a-#d), an enter button b14, a pause button b15, a stop button b16, and a playback button b17 are arranged in a lower part of the remote controller 200.

FIG. 9 shows the switching procedure from display of the AV contents based on activation of the AV playback switch 115 (ON position) to display of the data under control of the OS.

If the user recognizes the message M indicating the end of the OS booting displayed on the LCD 106, and pushes down, for example, the PC button b1 of the remote controller 200 (block S20 Yes), the CPU 101 sets the register provided in the south bridge 107 to enable both signal line 121a and the signal line 122a (block S21). By setting the signal line 121a and the signal line 122a to be enabled, the south bridge 107 can control the TV tuner 121 and the DVD drive 122. At the same time, the CPU 101 changes an active port of the VCONT 105 from a port connected to the signal line 104b to a port connected to the signal line 104a.

Further, the graphic controller 104 is able to output a signal to be transmitted from the north bridge 102 to the VCONT 105. Accordingly, for example, the data under the OS control such as a login screen can be displayed on the LCD 106 (block S22). After the OS boot, for example, the AV contents stored in the optical disk that is placed in the DVD drive 122 is displayed on the LCD 106 via the signal line 122a, the south bridge 107, the north bridge 102, the graphic controller 104, the signal line 104a, and the VCONT 105.

It is contemplated that the processing illustrated by block S21 may involve the CPU 101 setting the register provided in the south bridge 107 so that only signal line 122a is enabled. In this case, the south bridge 107 can control the DVD drive 122 and cannot control the TV tuner 121. Accordingly, although the AV contents outputted from the TV tuner 121 are inputted into the VCOUNT 105 via the signal line 104b, they can not be inputted in the south bridge 107 via the signal line 121a. Depending on such a configuration, for example, it is possible to prevent the TV program received by the TV tuner 121 from being stored in the HDD 108 or the main memory 103 via the south bridge 107.

Next, a switching procedure from the data display under the control of the OS into the display of the AV contents will be described below.

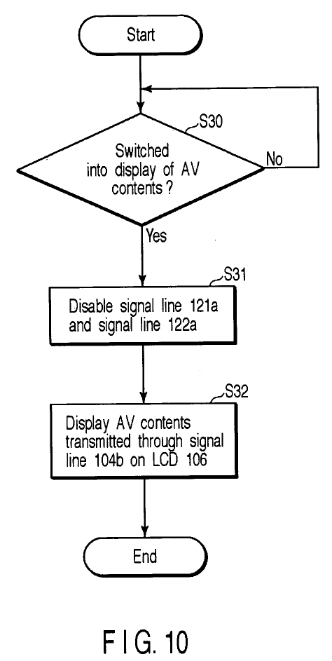

FIG. 10 shows a switching procedure from the data display under control of the OS to the display of the AV contents.

If the user powers on the TV button b2 of the remote controller 200 shown in FIG. 8 (block S30 Yes), the CPU 101 sets the resister provided in the south bridge 107 so the signal lines 121a and 122a are disabled (block S31). At the same time, the CPU 101 changes the active port of the VCONT 105 from the port connected to the signal line 104a to the port connected to the signal line 104b.

By disabling the signal lines 121a and 122a, the south bridge 107 cannot control the TV tuner 121 and the DVD drive 122. Further, the graphic controller 104 does not output the data under the control of the OS to be transmitted from the north bridge 102 to the VCOUNT 105.

A signal representing the TV program contents outputted from the TV tuner 121 or a signal representing the contents stored in the optical disk placed in the DVD drive 122 is outputted to the VCONT 105 through the signal line 104b. The VCONT 105 corrects the pictures included in the signal inputted from the TV tuner 121 or the DVD drive 122 by the appropriate picture processing, and outputs the signals into the LCD 106 (block S32).

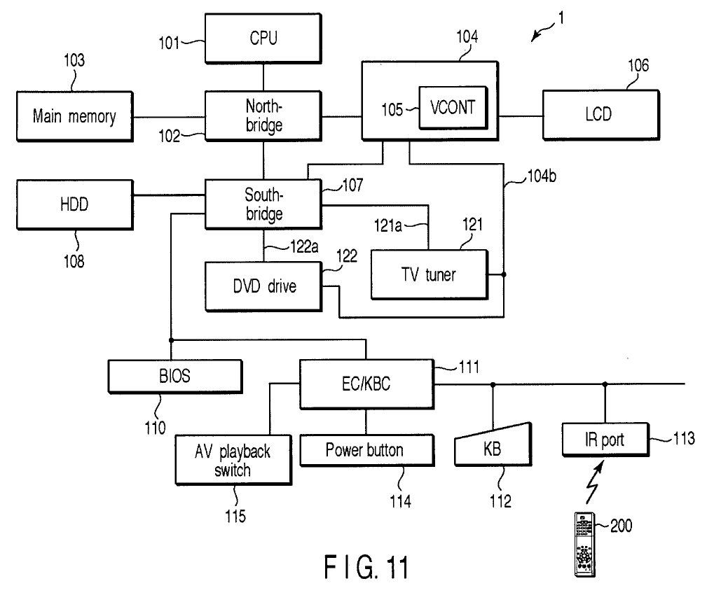

FIG. 11 shows a second embodiment of a component configuration of the information processing apparatus 1. The component configuration shown in FIG. 11 is different from the component configuration in the first embodiment shown in FIG. 2 in that the VCONT 105 is provided in the graphic controller 104. In other words, if the graphic controller 104, the south bridge 107, the DVD drive 122, and the TV tuner 121 are connected to the VCONT 105, any of two chip configuration of the graphic controller 104 and the VCONT 105 or one chip configuration that the VCONT 105 is located in the graphic controller 104 may be available.

According to the above-described BIOS control, during boot of the OS, for example, the AV contents outputted from the TV tuner 121 can be displayed on the LCD 106. In addition, after completion of the boot of the OS, switching from the display of the AV contents into the data display under the control of the OS, and further, switching of the data display under the control of the OS into the display of the AV contents or the like may be performed.

The present invention is not restricted to the above-described embodiment, but its composition elements may be modified within a scope not departing from the gist thereof for embodying the invention. Further, by combining the plural composition elements disclosed in the above-described embodiment appropriately, various kinds of inventions may be formed. For example, it is permissible to delete some composition elements indicated in the embodiment. Further, it is permissible to combine the composition elements of different embodiments appropriately.

Additional advantages and modifications will readily occur to those skilled in the art. Therefore, the invention in its broader aspects is not limited to the specific details and representative embodiments shown and described herein. Further, by combining the plural composition elements disclosed in the above-described embodiment appropriately, various kinds of inventions may be formed. For example, it is permissible to delete some composition elements indicated in the embodiment. Further, it is permissible to combine the composition elements of different embodiments appropriately. Accordingly, various modifications may be made without departing from the spirit or scope of the general inventive concept as defined by the appended claims and their equivalents.

1. An information processing apparatus, comprising:
a memory to store an operating system to be booted in response to a certain operation;
a content output unit; and
a display unit to display content data output from the content output unit even though a boot of the operating system has not completed.

2. An information processing apparatus according to claim 1, further comprising a controller to prevent the display unit from displaying data associated with the boot of the operating system during the boot of the operating system.

3. An information processing apparatus according to claim 2, wherein the controller controls the display unit to display data processed by the operating system after completion of the boot of the operating system.

4. An information processing apparatus according to claim 2, wherein the controller controls the display unit to display information showing that the boot is completed after the completion of the boot of the operating system.

5. An information processing apparatus according to claim 1, further comprising a first signal line arranged between the display unit and the content output unit, and a second signal line arranged between the display unit and the content output unit.

6. An information processing apparatus according to claim 5, further comprising a controller adapted to either disable or enable the first signal line.

7. An information processing apparatus according to claim 6, wherein the operating system controls content data transmitted through the first signal line.

8. An information processing apparatus according to claim 7, wherein the controller disables the first signal line until the boot of the operating system has completed, and in the meantime, the content data is transferred from the content output unit to the display unit through the second signal line.

9. An information processing apparatus according to claim 7, wherein the controller enables the first signal line after the boot of the operating system has completed, and in the meantime, the content data is transferred from the content output unit to the display unit through the first signal line.

10. An information processing apparatus according to claim 1, further comprising a correction unit which corrects pictures included in content output by the content output unit.

11. An information processing apparatus according to claim 10, wherein the display unit displays content in which pictures are corrected by the correction unit.

12. An information processing apparatus, comprising:
a display unit;
a correction unit which corrects pictures included in content displayed by the display unit;
a content output unit which outputs content data to the correction unit;
a memory which stores an operating system to be booted corresponding to a certain operation; and
a display control unit which provides data controlled by the operating system to the correction unit after booting the operating system is started,
wherein the correction unit provides one of data from the content output unit and data from the display control unit to the display unit.

13. An information processing apparatus according to claim 12, further comprising means for setting the data that the correction unit provides to the display unit.

14. A content data displaying method used in an information processing apparatus which has a function performed by an operating system, comprising:
booting the operating system;
outputting a content data; and
displaying the content data on a display even if the booting of the operating system has not completed.

15. A content data displaying method according to claim 14, further comprising displaying data under control by the operating system after completion of the booting of the operating system.

16. A content data displaying method according to claim 14, further comprising displaying, after completion of the boot, information indicating that the booting of the operating system has completed.

17. A content data displaying method according to claim 14, further comprising correcting pictures included in content data before displaying.
